(19) United States
(12) Patent Application Publication
(10) Pub. No.: US 2002/0125188 A1
(43) Pub. Date: Sep. 12, 2002

(54) Liquid filter having interchangeable spin-on canister filter and cartridge filter, and methods

(76) Inventors: John R. Hacker, Bloomington, MN (US); David B. Harder, Burnsville, MN (US); Jess T. Nordby, Minneapolis, MN (US); Michael J. Gustafson, Inver Grove Heights, MN (US); Alan D. Klein JR., Prescott, WI (US)

Correspondence Address: MERCHANT & GOULD PC, P.O. BOX 2903, MINNEAPOLIS, MN, 55402-0903, US

(21) Appl. No.: 09/800,413

(22) Filed: Mar. 6, 2001

(51) Int. Cl. B01D 35/30

(52) U.S. Cl. 210/443; 210/450

(57) ABSTRACT

A liquid filter assembly includes a filter head having an interchangeable spin-on canister filter and a bowl-cartridge filter. Methods of using the liquid filter assembly include providing a filter head capable of operably receiving both a spin-on canister filter and a bowl-cartridge filter. The method also includes operably installing one of the spin-on canister filter and the bowl-cartridge filter onto the filter head to provide a filter assembly. After a period of use, the spin-on canister filter or bowl-cartridge filter is removed and replaced. The replacement can include, interchangeably, a spin-on canister filter and a bowl-cartridge filter. Constructions for accommodating an interchangeable system include preferred arrangements of mechanical connection structure.

### TECHNICAL FIELD

This disclosure relates to filter assemblies, in particular liquid filter assemblies. In certain aspects, this disclosure relates to filtration assemblies for hydraulic, oil, and fuel systems. The disclosure includes both spin-on canister filters and cartridge filters.

### BACKGROUND

Filters are commonly used in connection with lubrication systems and fuel systems for internal combustion engines, and hydraulic systems for heavy-duty equipment. Filters are also used in many other types of liquid systems. In these types of systems, the filter is changed periodically. In the art, there are at least two standard types of filters used. One type is a spin-on canister filter, while the other is a bowl-cartridge filter.

Spin-on canister filters are disposable units, which typically include a single-use housing holding a permanently mounted, non-replaceable filter element (cartridge filter). The canister holding the cartridge filter is usually spun onto a filter head, by threaded engagement. The liquid to be cleaned passes from the filter head and into the housing for filtering. The cleaned liquid exits the housing and re-enters the filter head. After some period of use, the spin-on canister filter is removed from the filter head and is discarded. A new spin-on canister filter is then mounted onto the filter head.

Bowl-cartridge filters, on the other hand, typically include a re-usable bowl holding a replaceable filter element (cartridge filter). Bowl-cartridge filters are sometimes preferred or required to be used instead of spin-on canister filters due to disposal or other issues. Bowl-cartridge filters are also mounted onto a filter head, wherein liquid to be cleaned passes through the filter head, into the bowl, through the replaceable cartridge filter, outside of the bowl, and back into the filter head. After a period of use, the bowl-cartridge filter is removed from the filter head, and the replaceable cartridge filter is removed from the re-usable bowl. The old cartridge filter is discarded, and replaced with a new cartridge filter. The new cartridge filter is operably mounted into the re-usable bowl, to provide a refurbished bowl-cartridge filter. This refurbished bowl-cartridge filter, containing the new cartridge filter, is then mounted onto the filter head.

### SUMMARY OF THE DISCLOSURE

A filter assembly utilizes a filter head and filter. The filter is one of a spin-on canister filter and a bowl-cartridge filter. The filter head includes structure that enables it to accept, interchangeably, each of the spin-on canister filter and bowl-cartridge filter.

A method of using a liquid filter assembly includes providing a filter head capable of operably receiving both a spin-on canister filter and a bowl-cartridge filter. The method further includes a step of operably installing one of the spin-on canister filter and the bowl-cartridge filter onto the filter head to provide a filter assembly.

### BRIEF DESCRIPTION OF THE DRAWINGS

FIG. 1 is an exploded, perspective view of a first embodiment of a liquid filter assembly including a filter head and a bowl-cartridge filter;

FIG. 2 is a cross-sectional view of the filter assembly depicted in FIG. 1 and shown in operable assembly;

FIG. 3 is an exploded, perspective view of a filter assembly including the filter head shown in FIGS. 1 and 2 and a spin-on canister filter;

FIG. 4 is a cross-sectional view of the filter assembly depicted in FIG. 3 and shown in operable assembly;

FIG. 5 is an exploded, perspective view of a second embodiment of a filter head and a bowl-cartridge filter;

FIG. 6 is a cross-sectional view of the filter assembly of FIG. 5;

FIG. 7 is an exploded, perspective view of the filter head depicted in FIGS. 5 and 6 and a spin-on canister filter;

FIG. 8 is a cross-sectional view of the filter assembly depicted in FIG. 7;

FIG. 9 is an exploded, perspective view of a filter assembly including the filter head depicted in FIGS. 5-8 and an alternate embodiment of a spin-on canister filter;

FIG. 10 is a cross-sectional view of the filter assembly depicted in FIG. 9;

FIG. 11 is an exploded, perspective view of another embodiment of a filter assembly including a filter head and a bowl-cartridge filter;

FIG. 12 is a cross-sectional view of the filter assembly depicted in FIG. 11;

FIG. 13 is an exploded, perspective view of a filter assembly including the same filter head depicted in FIGS. 11 and 12 and a spin-on canister filter;

FIG. 14 is cross-sectional view of the filter assembly depicted in FIG. 13;

FIG. 15 is an exploded, perspective view of a filter assembly including the same filter head depicted in FIGS. 11-14 and with an alternate embodiment of a spin-on canister filter;

FIG. 16 is a cross-sectional view of the filter assembly depicted in FIG. 15;

FIG. 17 is an exploded, perspective view of another embodiment of a filter assembly including a filter head and a bowl-cartridge filter;

FIG. 18 is a cross-sectional view of the filter assembly depicted in FIG. 17;

FIG. 19 is an exploded, perspective view of a filter assembly including the same filter head depicted in FIGS. 17 and 18 and a spin-on canister filter;

FIG. 20 is a cross-sectional view of the filter assembly depicted in FIG. 19; and

FIG. 21 is a schematic depiction of a piece of equipment having an engine utilizing various liquid filter assemblies depicted in any one of FIGS. 1-20.

### DETAILED DESCRIPTION

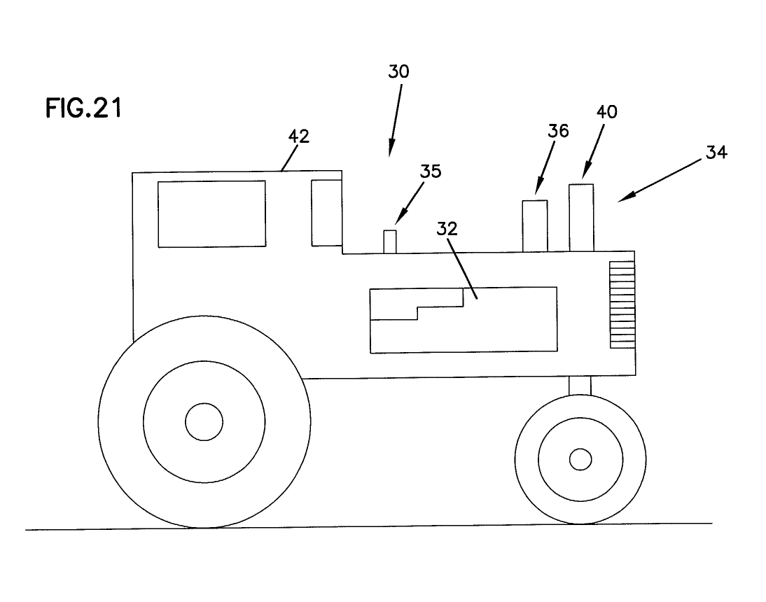

Attention is first directed to FIG. 21. FIG. 21 is a schematic depiction of equipment 30 including an engine 32. The equipment 30 includes a lubrication system 34, a fuel system 35, and a hydraulic system 36. The lubrication system 34, the fuel system 35, and the hydraulic system 36 will need to have the liquid in the system (oil, fuel, or hydraulic fluid) cleaned. To provide the cleaning function, a liquid filter assembly 40 is utilized. In the particular embodiment shown in FIG. 21, there are three liquid filter assemblies 40 shown, one for the lubrication system 34, one for the fuel system 35, and one for the hydraulic system 36. The equipment 30 shown in FIG. 21 is a tractor 42. The liquid filter assembly 40 is usable with other types of equipment 30 including bulldozers, skid-steers, pay loaders, mining equipment, over the highway trucks, off-road trucks, combines, and other types of equipment.

Liquid filter assembly 40, constructed according to principles of this disclosure, is also usable in other systems, such as generators, and any system with an engine or a hydraulic system. Such engines can be small, such as 2 HP.

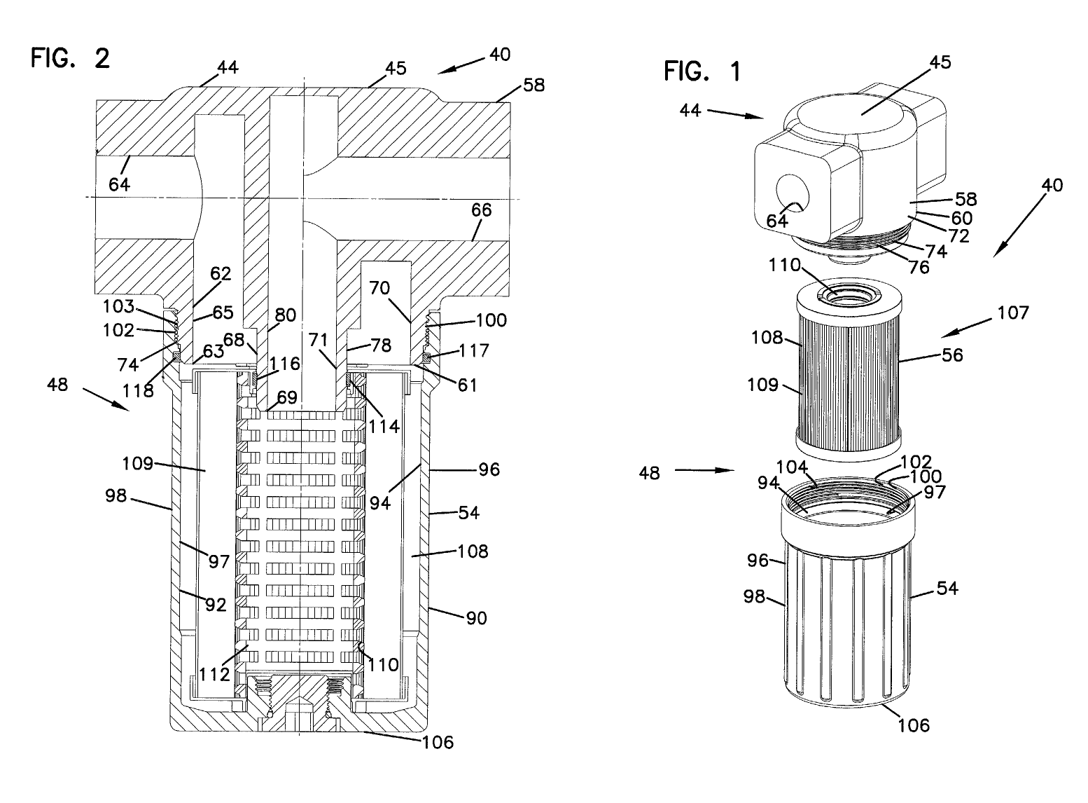

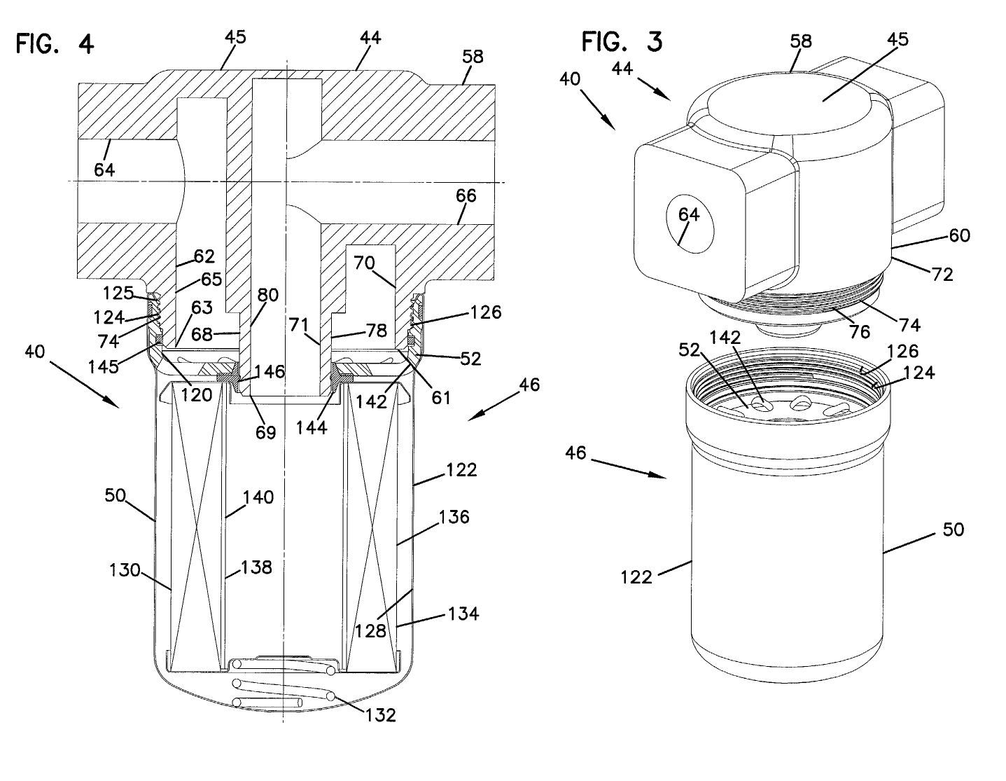

Attention is now drawn to FIG. 1. The liquid filter assembly 40 is shown in an exploded, perspective view. The liquid filter assembly 40 includes a filter head 44 and one of a spin-on canister filter 46 (FIGS. 3 and 4) and a bowl-cartridge filter 48. The filter head 44 is typically positioned in lubrication systems, such as the system 34 (FIG. 21), fuel system 35 (FIG. 21), or hydraulic system 36 (FIG. 21). Fluid is directed from the system 34, 35, 36 by the filter head 44 and through the filter, either spin-on canister filter 46 or bowl-cartridge filter 48, (depending upon which one is connected to the filter head 44).

By the term “spin-on canister filter”, it is meant a filter that includes a cartridge filter (filter element) installed within a housing, in which the cartridge filter is permanently mounted and non-replaceable. Spin-on canister filters are typically “single-use.” By “single-use”, it is meant that once the life of the cartridge filter is exhausted, usually after some number of hours of operation, the entire spin-on canister filter is removed from the filter head, discarded, and replaced with a totally new spin-on canister filter containing an unused cartridge filter.

By the term “bowl-cartridge filter”, it is meant a filter having a re-usable housing or bowl holding a replaceable cartridge filter (filter element). After a period of use, after some number of hours, when the cartridge filter becomes clogged or restriction increases to an unacceptable level, the bowl-cartridge filter is removed from the filter head; the cartridge filter is removed from the bowl and a new, unused cartridge filter is installed within the bowl. The bowl with the new cartridge filter is then mounted onto the filter head.

The filter head 44 is capable of operably receiving both spin-on canister filter 46 and bowl-cartridge filter 48. By “operably receiving”, it is meant that the filter head 44 includes appropriate structure for engaging the spin-on canister 46 and the bowl-cartridge filter 48, such that fluid to be cleaned is directed through the appropriate channels and cleans the fluid as intended. By the term “receiving both”, it is meant that both types of filters, the spin-on canister filter 46 and the bowl-cartridge filter 48, can be mounted on the filter head 44, but separately and independently of each other. In other words, the filter head 44 cannot accommodate more than one filter assembly at the same time. However, the filter head 44 can accommodate, or operably receive, both types of spin-on canister filter 46 and bowl-cartridge filter 48 interchangeably, sequentially, and independently of each other. As such, the liquid filter assembly 40 is considered to be “interchangeable” because it does accommodate or utilize both spin-on canister filters and bowl-cartridge filters.

In reference to FIGS. 1 and 2, the bowl-cartridge filter 48 has a reusable housing or bowl 54 operably holding a removable and replaceable cartridge filter (filter element) 56. In FIG. 1, the cartridge filter 56 is depicted as removed from the bowl 54.

In reference to FIGS. 3 and 4, the spin-on canister filter 46 includes single-use housing 50 and baffle plate 52. As will be described below, the housing 50 defines a filter interior permanently holding a non-replaceable cartridge filter (filter element).

Attention is now directed to FIGS. 2 and 4, depicting cross-sectional views of the filter head 44 in operable connection with the bowl-cartridge filter 48 (FIG. 2) and the spin-on canister filter 46 (FIG. 4). The filter head 44 includes a block 58 including a continuous exterior wall member forming an outer tube 60 surrounding an internal volume 62. The filter head block 58 defines a first port 64, which in forward flow systems is an inlet port 64, and a second port 66, which in forward flow systems is an outlet port 66, and an interior or center tube 68, which is within the internal volume 62 and is circumscribed by the outer tube 60. The interior tube 68, in use, will extend or project into the interior of the spin-on canister filter 46 and bowl-cartridge filter 48, depending upon which type of filter is mounted on the filter head 44. As can be seen in FIGS. 2 and 3, the interior tube 68 is in fluid-flow communication with the outlet port 66. In reverse flow systems, the first port 64 would be an outlet port, while the second port 66 would be an inlet port.

The continuous exterior wall member 60 is preferably the outermost wall of the filter head 44. By “outermost wall”, it is meant that there are no other walls or structures in the filter head block 58 that extend between it (the wall member 60) and the outside environment, before the filter head 44 is operably connected to one of the canister filters 46 or bowl-cartridge filters 48. As can be seen in FIGS. 1 and 3, there are no other walls that are part of the block 58 that circumscribe or extend between the wall member 60 and the outside of the block 58.

Preferably, the continuous exterior wall member 60 is thin, having a cross-sectional thickness no greater than 10 mm and preferably between 3-5 mm.

The continuous exterior wall member 60 has an inside surface 70 that is adjacent to the internal volume 62 and an opposite, outside surface 72, which is also in open communication with the region exterior of the filter head 44, since the wall member 60 is an outermost wall of the block 58.

In preferred arrangements, at least one of the inside surface 70 and outside surface 72 will have first mechanical connection structure 74. The first mechanical connection structure 74 includes many types of arrangements. Of those arrangements possible, examples include threads, bayonet connections, bead and groove connections, etc. In the particular embodiment illustrated, the first connection structure 74 includes a first plurality of threads 76. In this particular embodiment, the first plurality of threads 76 is located on the outside surface 72 of the wall member 60. As will be seen below, in other embodiments, the first plurality of threads 76 is located along the inside surface 70 of the wall member 60.

The interior tube 68 includes an outer portion 78 and an opposite, inner portion 80. The outer portion 78 includes the section of the interior tube 68 that is closest to the wall member 60 while the inner portion 80 is on the side of the interior tube 68 opposite from the outer portion 78. In some embodiments, the outer portion 78 will include mechanical connection structure, such as threads, for mateably engaging the spin-on canister filter 46; but in this embodiment, the outer portion 78 is smooth with a non-threaded surface.

The outer tube 60 defines an end 61, an end port 63, and a fluid passageway 65. The fluid passageway 65 extends between the inlet port 64 and the end port 63. The end 63 forms the bottom rim of the outer tube 60.

The interior tube 68 defines an end port 69 and a fluid passageway 71 between the end port 69 and the outlet port 66.

In preferred embodiments, the interior tube 68 projects or extends outwardly from the end 61 of the outer tube 60. In other words, the interior tube 68 is the furthermost point from the end face 45 of the filter head 44, compared relative to the outer tube 60.

In some embodiments, the filter head 44 may include a bypass valve arrangement (not shown). The bypass valve arrangement may be of the type typically used in conventional filter heads. The bypass valve arrangement will ensure fluid flow to the system in the event the filter plugs. Also, it protects the filter from over-pressurization.

Turning now to FIG. 2, the bowl-cartridge filter 48 is explained in further detail. The housing or bowl 54 is shown in cross-section, including a thin wall 90 forming the bowl 54 and defining an interior 92. The wall 90 has a continuous wall surface 94, which can be the outermost exterior surface, or spaced closely to the outermost exterior surface, meaning no more than 10 mm, preferably no more than 4 mm, from the outermost exterior surface. In the particular embodiment illustrated, the continuous wall surface 94 is not the outermost exterior surface of the bowl 54, but is spaced less than 3.05 mm from the outermost exterior surface 96. In the particular embodiment shown, the wall 90 of the bowl 54 is thin with an internal side 97 and an external side 98. In this particular embodiment, the continuous wall surface 94 is the same as the internal side 97, and the outermost exterior surface 96 is the same as the external side 98.

Preferably, the continuous wall surface 94 includes second mechanical connection structure 100. The second mechanical connection structure preferably engages or interlocks with the first mechanical connection structure 74. In the particular instance shown in FIG. 2, the second mechanical connection structure 100 includes a second plurality of threads 102. FIG. 2 shows the filter head 44 operably connected to the bowl-cartridge filter 48 by threadable engagement between the first plurality of threads 76 and the second plurality of threads 102 to form a threaded region 103. In some embodiments, as will be explained below, the mechanical connection structure 100 is located on the outermost exterior surface 96 or external side 98 of the continuous wall surface 94. The threaded region 103 has a total cross-sectional thickness of no more than 10 mm, often no more than 8 mm.

The bowl 54 operably holds removable and replaceable cartridge filter 56 within interior 92. The cartridge filter 56 is removable and replaceable from the bowl 54, when the bowl 54 is removed from the filter head 44, leaving an open end 104 of the bowl 54. The cartridge filter 56 can be removed and replaced through the open end 104. The bowl 54 includes an opposite end 106, which is closed.

The cartridge filter 56 is preferably a cylindrical construction 107 of media 108, typically pleated media 109, constructed of, for example, cellulose or synthetic media. The cylindrical construction of media 108 defines an open filter interior 110. Typically, and in the embodiment illustrated, there is an interior filter liner 112 or support, typically constructed of non-metallic materials such as plastic but may also include perforated metal, or expanded metal. In some arrangements, there is also an outer liner on the upstream side of the media 108.

As can be seen in FIG. 2, when the bowl-cartridge filter 48 is operably assembled onto the filter head 44, the interior tube 68 extends or projects into the open filter interior 110. In typical constructions, there is a seal arrangement 114 between the cartridge filter 56 and the interior tube 68 to form a seal 116 therebetween. The seal 116 prevents leakage between the filter 48 and the flow passageway 71. The filter 148 is in liquid flow communication with the outer tube end port 63 and the interior tube end port 69, when the filter 48 is operably assembled onto the head 44.

There is also a seal arrangement 117 that forms a seal 118 between the outer tube 60 and the filter 48. The seal 118 prevents leakage between the flow passage 65 and the filter 48.

Operation of the liquid filter assembly 40 shown in FIG. 2 should now be apparent. Liquid to be filtered enters the filter head 44 through the inlet port 64. The fluid is directed into the interior 92 of the bowl 54, and then passes through the media 108 into the open filter interior 110. From the open filter interior 110, the cleaned fluid then passes into the filter head 44 through the interior tube 68 along the inner portion 80. The cleaned fluid then passes through the outlet port 66 and to downstream components of the lube system 34, or hydraulic system 36 or fuel system 35. The seal 116 helps to prevent leakage of unfiltered liquid from passing to the clean side (that is, the inner portion 80 of tube 68 and outlet port 66) without passing through the filter media 108 first.

After some period of use, the media 108 will become clogged or occluded, increasing the restriction within the cartridge filter 48. At this point, the bowl 54 is removed from the filter head 44 by unscrewing the bowl 54 from the head 44. The second plurality of threads 102 is disengaged from the first plurality of threads 76 to remove the bowl-cartridge filter 48 from the filter head 44. This exposes the opening 104 in the bowl 54 and permits access to the cartridge filter 56. The cartridge filter 56 is removed from the bowl 54 through the open end 104 and is discarded. A new, unused, cartridge filter is then operably installed in the same bowl 54. The bowl-cartridge filter 48 containing the new cartridge filter may then be again operably mounted onto the filter head 44. Alternatively, the spin-on canister 46 may be mounted onto the same filter head 44. Details on the spin-on canister now follow.

Attention is directed to FIG. 4. A cross-sectional view of the spin-on canister 46 preferably assembled and connected with filter head 44 is depicted. The filter housing 50 includes as part of it, baffle plate 52. As with the bowl-cartridge filter 48, the housing 50, including baffle plate 52, defines a continuous wall surface 120. In the embodiment illustrated, the continuous wall surface 120 is an internal surface, spaced no more than 10 mm, preferably no more than 5.5 mm from an outer most exterior surface 122 of the housing 50. The continuous wall surface 120 defines second mechanical connection structure 124, which in this case, is depicted as threads 126. The threads 126 engage the threads 74 to form threaded region 125. The threaded region 125, in many embodiments, has a total cross-sectional thickness no greater than 10 mm, often no more than 8 or 9 mm.

The housing 50 defines an interior volume 128. A cartridge filter 130 is permanently and non-removably oriented and secured within the interior volume 128. A biasing mechanism such as spring 132 urges the cartridge filter 130 against the sealing arrangement 144. The cartridge filter 130 is preferably a cylindrical construction having a region of media 134, preferably pleated media 136. As with the bowl-cartridge filter 48, the media 134 defines an open filter interior 138 and may include an internal support or liner 140.

The baffle plate 52 includes a plurality of apertures 142 to permit fluid flow from the filter head 44 into the interior volume 128.

Analogous to the arrangement of FIG. 2, the interior tube 68 of the filter head 44 likewise protrudes or extends to the open filter interior 138, and a sealing arrangement 144 forms a seal 146 between the tube 68 and the cartridge filter 130. There is also a seal at 145 to prevent leakage between the filter head 44 and the filter 40.

In operation, liquid to be filtered is directed from the liquid system through the inlet port 64 of the filter head 44. It then flows through the apertures 142 and the baffle plate 52 and into the volume 128. The liquid then flows through the media 134 and into the open filter interior 138. The liquid then flows through the interior tube 68 along the inner portion 80, and ultimately exits the filter head 44 through the outlet port 66. The seal 146 prevents unfiltered liquid from bypassing the media 134 and flowing directly to the outlet port 66.

After some period of use, the filter media 134 will start to become clogged or occluded, introducing increased restriction through the spin-on canister filter 46. At this point, the spin-on canister filter 46 is removed from the filter head 44, discarded, and replaced with a new spin-on canister filter. Alternatively, the replacement includes the bowl-cartridge filter 48. To remove the spin-on canister filter 46 from the filter head 44, the second plurality of threads 126 is disengaged from the first plurality of threads 76 to separate the spin-on canister filter 46 from the filter head 44. The entire spin-on canister filter 46, including the housing 50 and permanently mounted, non-replaceable internal cartridge filter 130 is discarded. A second new spin-on canister filter with a new housing having a new, unused permanently mounted non-replaceable cartridge filter 130 may be remounted onto the head 44.

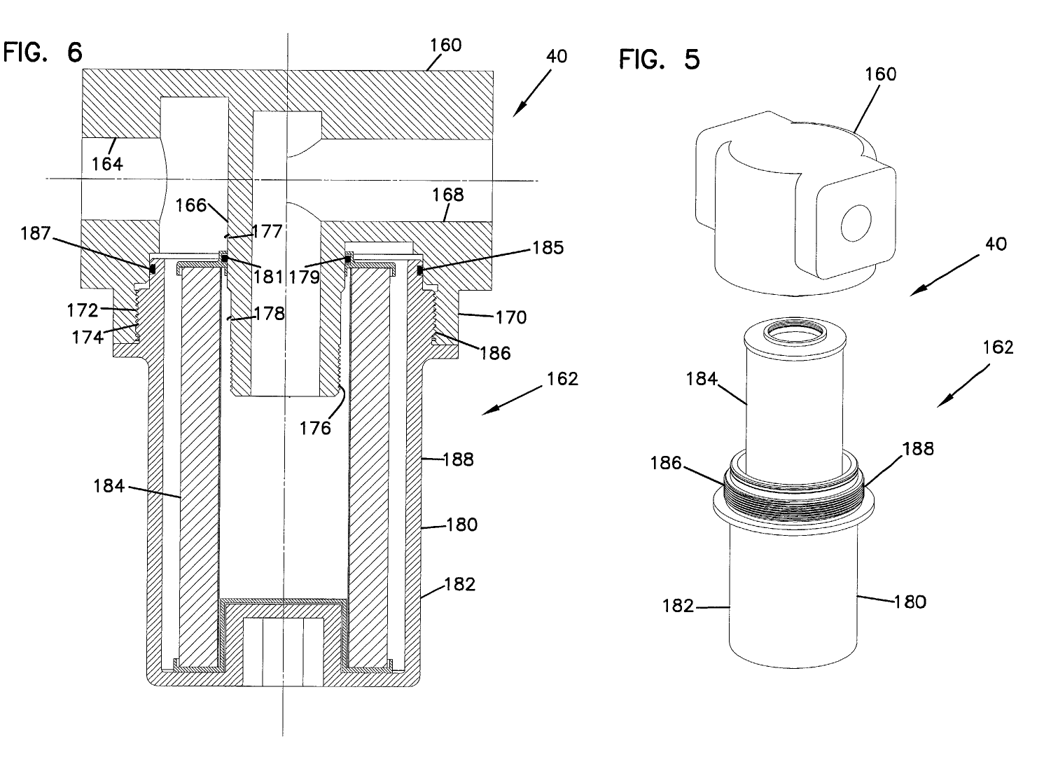

Attention is directed to FIGS. 5 and 6, where an alternative embodiment of the liquid filter assembly is depicted in cross-sectional view. The liquid filter assembly 40 depicted in FIG. 5 includes a filter head 160 and a bowl-cartridge filter 162. The filter head 160 includes inlet port 164, interior tube 166, outlet port 168 and wall member or outer tube 170. In this embodiment, wall member 170 includes threads 172 along inside surface 174. In this embodiment, also note that the interior tube 166 includes a second plurality of threads 176 along the outer portion 178 of the interior tube 166.

The interior tube 166 also defines a sealing region 177 along the outer portion 178. The sealing region 177 is oriented above the threads 176, i.e. between the threads 176 and the outlet port 168. The sealing region 177 is preferably cylindrical, having a circular cross section. The diameter of the cross section of the sealing region 177 is greater than the diameter of the threaded region 176. This smaller diameter of the threaded region 176 permits a seal member 179 to pass over the threaded region 176, without damage to the seal member 179. The seal member 179 may then form a seal 181 between the cartridge 184 and the seal region 177.

The bowl-cartridge filter 162 is constructed analogously as the bowl-cartridge filter 48, including a bowl 180 comprising a wall 182, a removable and replaceable cartridge filter 184, and a third plurality of threads 186. In this embodiment, however, the plurality of threads 186 is located along the outermost exterior surface 188 of the wall 182. The third plurality of threads 186 engages the first plurality of threads 172 of the filter head 160. Note that in this embodiment, the second plurality of threads 176 does not engage any mating threads of the bowl-cartridge filter 162.

A seal member 185 forms a seal 187 between the bowl 180 and the outer tube 170 to prevent leakage between the head 160 and the filter 162.

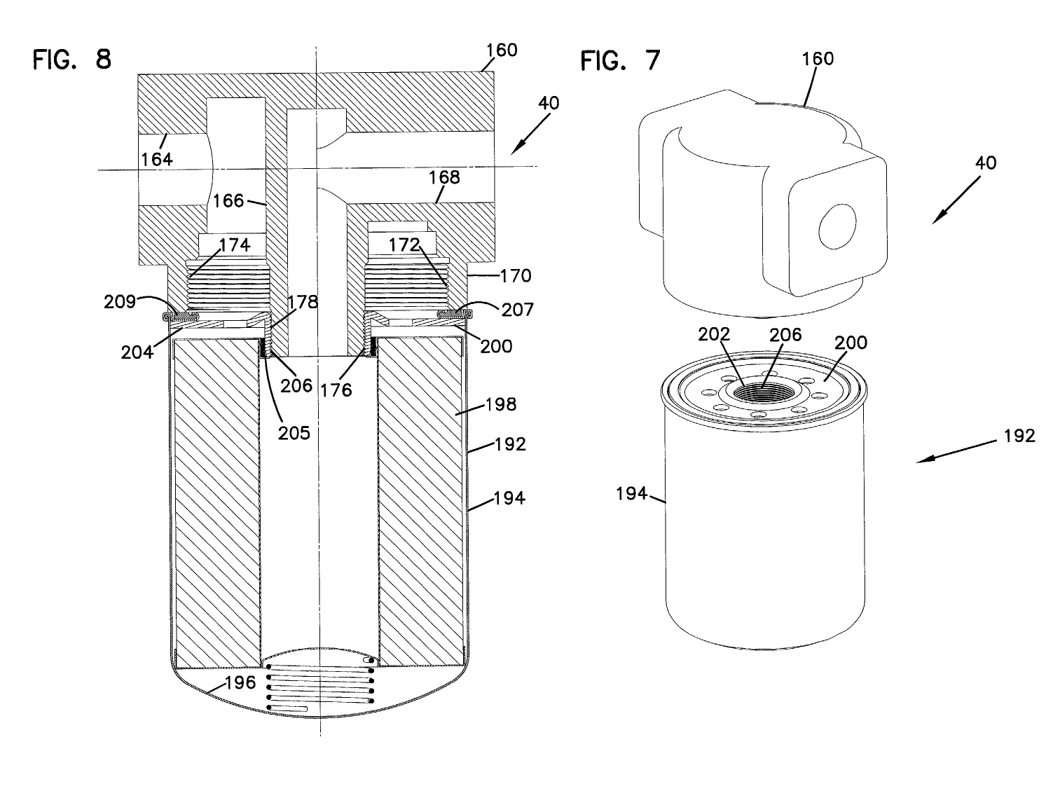

Attention is now directed to FIGS. 7 and 8. FIG. 8 illustrates a cross-sectional view of the filter head 160 depicted in FIG. 6, now operably engaged with a spin-on canister filter 192. The spin-on canister filter 192 includes a can or housing 194 defining an interior 196 and holding within its interior 196 a permanently mounted, non-replaceable cartridge filter 198. A baffle plate is depicted at 200 and forms part of the housing 194. In this embodiment, the baffle plate 200 defines a central aperture 202, for accommodating and receiving the interior tube 166 of the filter head 160. The central aperture 202 is defined by an extension of wall 204 having an internally directed third plurality of threads 206. The third plurality of threads 206 threadably engages the second plurality of threads 176 of the interior tube 166. Note that in this embodiment, the first plurality of threads 172 is not utilized. (Of course, the first plurality of threads 172 is utilized when the filter head 160 operably engages the cartridge filter 162, shown in FIG. 4). A seal is formed at 205 and 207. The seal 207 forms a face seal between the end 209 of the outer tube 170 and the baffle plate 200.

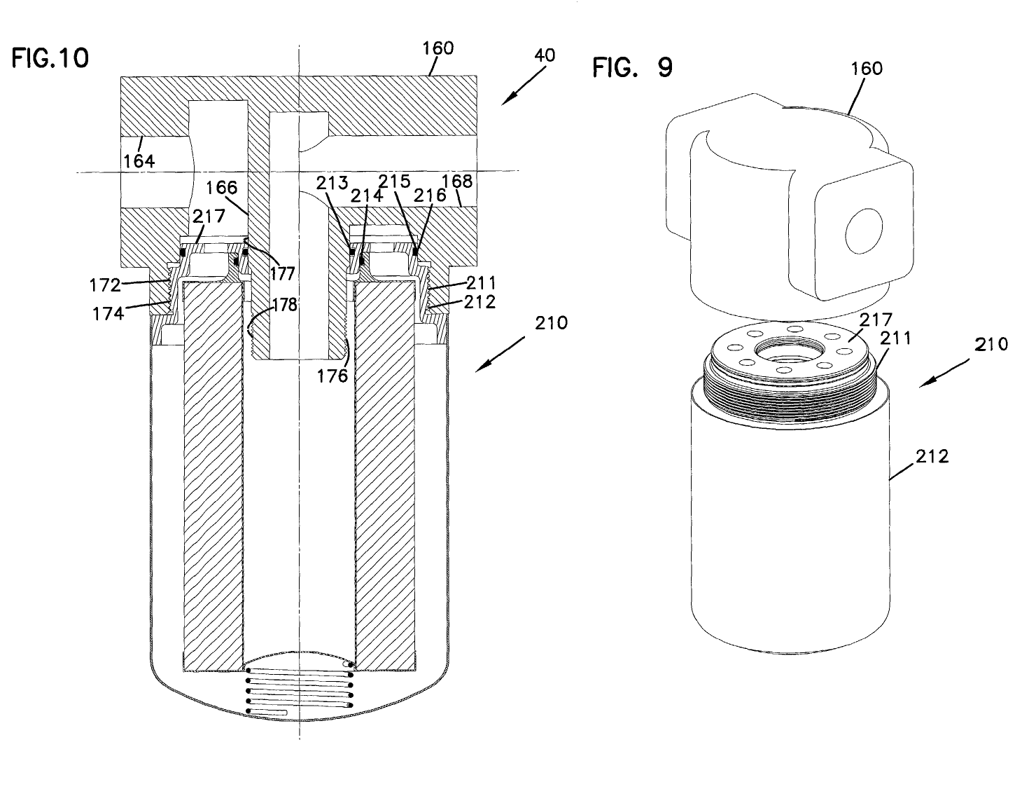

In reference now to FIGS. 9 and 10, there is another spin-on canister filter 210 operably engaged with the filter head 160 depicted. The spin-on canister filter 210 is analogous to the spin-on canister filter 192, with the exception of the manner in which it engages with the filter head 160. In the embodiment of FIGS. 9 and 10, the spin-on canister filter 210 includes a plurality of threads 211 on the exterior wall 212. The threads 211 engage the threads 172 of the filter head 160, to provide an operable connection. Note that in this embodiment, the threads 176 in the filter head 160 are not utilized. The spin-on canister filter 210 includes a plurality of seal members 213, 214, 215 to provide seals with the filter head. The seal member 213 presses against the seal surface 177 of the internal tube 166 to provide a seal therebetween. The seal member 215 presses against the portion 216 of the filter head to provide a seal, while the seal member 214 presses against a portion of the baffle plate 217 to provide a seal.

It can be appreciated that the filter head 160 can accommodate both the bowl-cartridge filter 162 and either of the spin-on canister filters 192, 210 as described above.

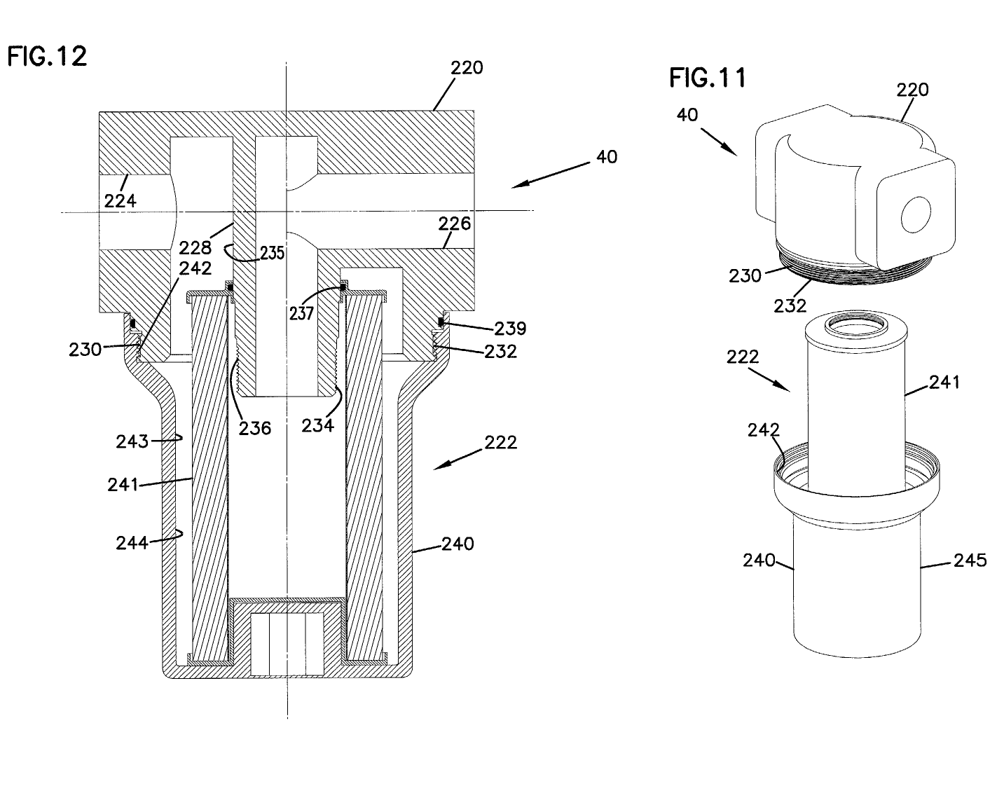

Attention is directed to FIGS. 11 and 12, where another embodiment of a filter assembly 40 is depicted. FIG. 12 illustrates a filter head 220 in operable connection with a bowl-cartridge filter 222. The filter head 220 includes inlet port 224, outlet port 226, interior tube 228, and outer tube or continuous exterior wall member 230. In this embodiment, the first plurality of threads 232 is on an outermost exterior surface of the filter head 220. Also, note that the interior tube 228 includes a second plurality of threads 234, along outer portion 236 of the interior tube 228. The interior tube 228 also includes sealing surface 235 with a larger diameter than the threaded region 234.

The bowl-cartridge filter 222 includes a bowl 240, a removable and replaceable cartridge filter 241, and a connection structure including a plurality of threads 242 along a continuous wall surface 243. In this embodiment, the continuous wall surface 243 also corresponds to the internal side 244 of the outermost wall 245. Note that the bowl-cartridge filter 222 engages the filter head 220 through a connection between the first plurality 232 and the third plurality of threads 242. A seal is formed at 237 and 239, analogous to other assemblies described above.

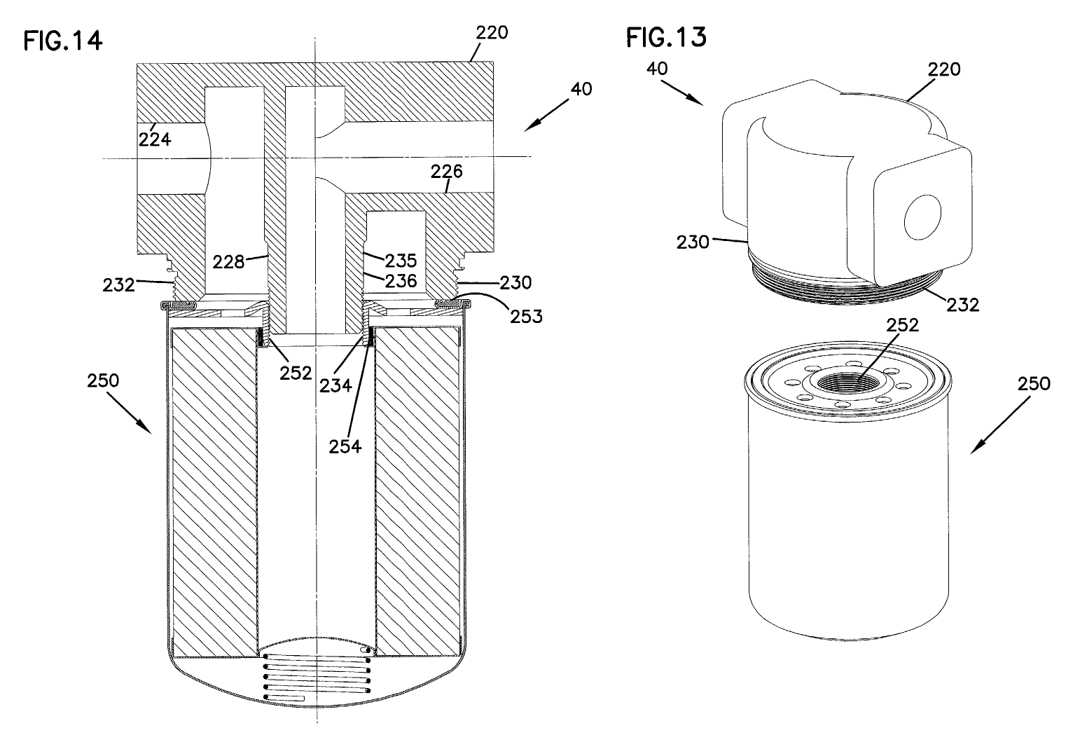

Turning now to FIGS. 13 and 14, the filter head 220 is depicted with a spin-on canister filter 250. The spin-on canister filter 250 is constructed analogously as the spin-on canister filter 192 depicted in FIGS. 7 and 8. As such, the spin-on canister filter 250 includes a third plurality of threads 252 to engage the second plurality of threads 234 on the filter head 220. In FIG. 14, note that the first plurality of threads 230 are not otherwise utilized. Seals are formed at 253 (face seal) and at 254.

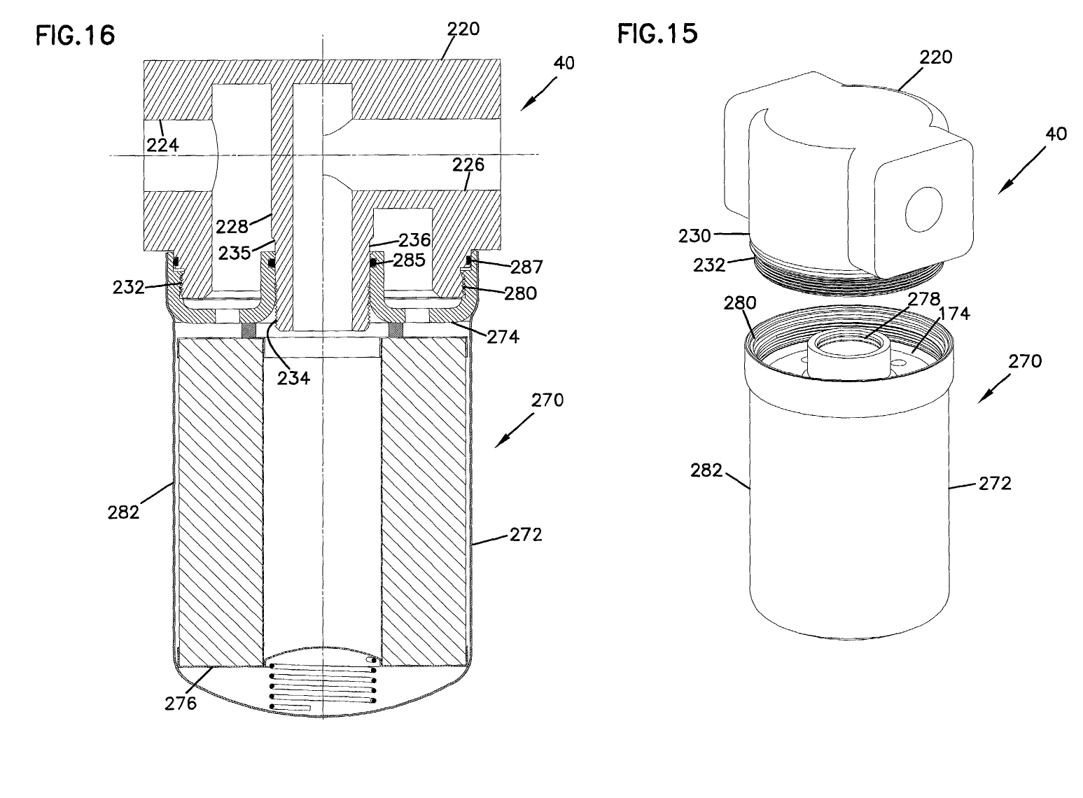

In FIGS. 15 and 16, another embodiment of a spin-on canister filter 270 is depicted. The spin-on canister filter 270 of FIGS. 15 and 16 includes an outer housing or can 272, baffle plate 274 which forms part of the housing 272, and a non-replaceable cartridge filter 276. The baffle plate 274 defines a central aperture 278, for accommodating and receiving the interior tube 228 of the filter head 220. The central aperture 278, in this embodiment, is smooth and non-threaded. The baffle plate 274 also includes an internally directed third plurality of threads 280 to threadably engage the first plurality of threads 232 of the filter head 220. The third plurality of threads 280 is no more than 10 mm, preferably no more than 6 mm, from the outermost exterior 282. A seal 285 is formed between the baffle plate 274 and center tube 228. A seal 287 is also formed between the outer tube 230 and the filter 270, in particular, the baffle plate 274.

It should be appreciated that the filter head 220 can accommodate both the bowl-cartridge filter 222 and either of the spin-on canister filters 250, 270, interchangeably.

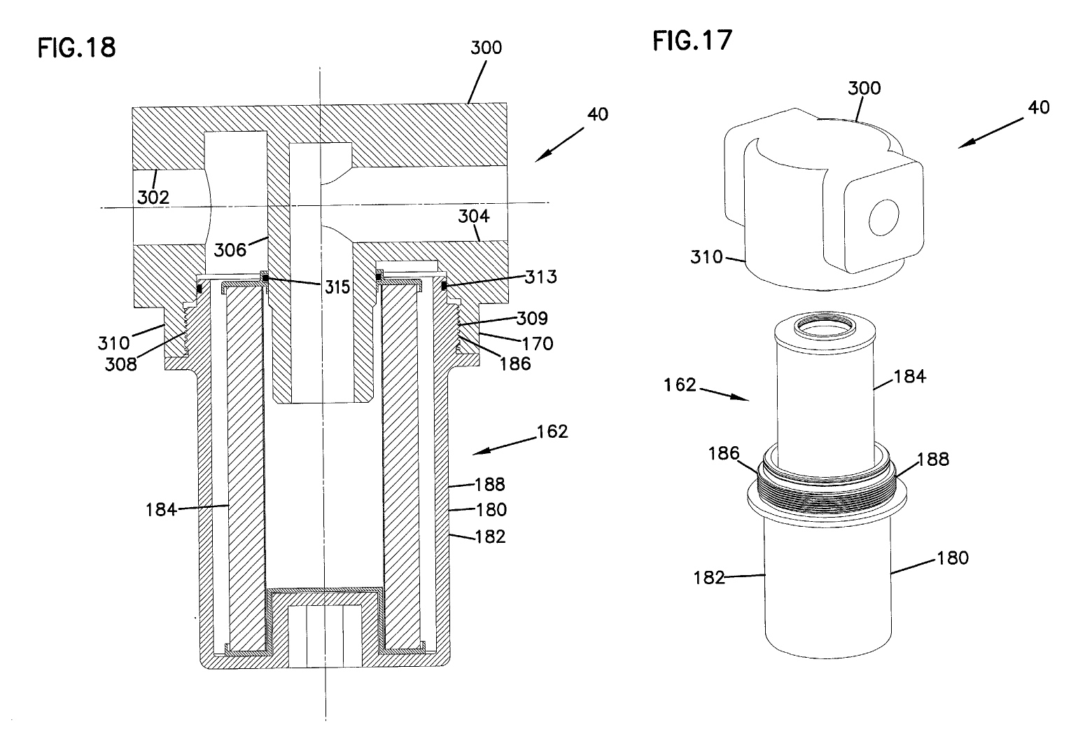

Attention is now directed to FIGS. 17 and 18, where an alternative embodiment of the liquid filter assembly 40 is illustrated. The liquid filter assembly 40 depicted in FIGS. 17 and 18 includes a filter head 300 and bowl-cartridge filter 162. The bowl-cartridge filter 162 is the same as described in connection with FIGS. 5 and 6. In this embodiment, however, there is an alternate construction for the filter head 300. The filter head 300 includes an inlet 302, an outlet 304, and a center or internal tube 306. The filter head 300 also includes a first plurality of threads 308, which are internally directed, i.e., along the inner surface 309 of the outer tube 310 of the filter head 40. In this embodiment, the filter head 300 includes a smooth, unthreaded internal tube 306.

It can be seen in FIG. 18 that the plurality of threads 186 on the bowl-cartridge filter 162 engages the threads 308 on the filter head 300 for operable assembly. Seals are formed between the filter 162 and the filter head 300 at 313, 315.

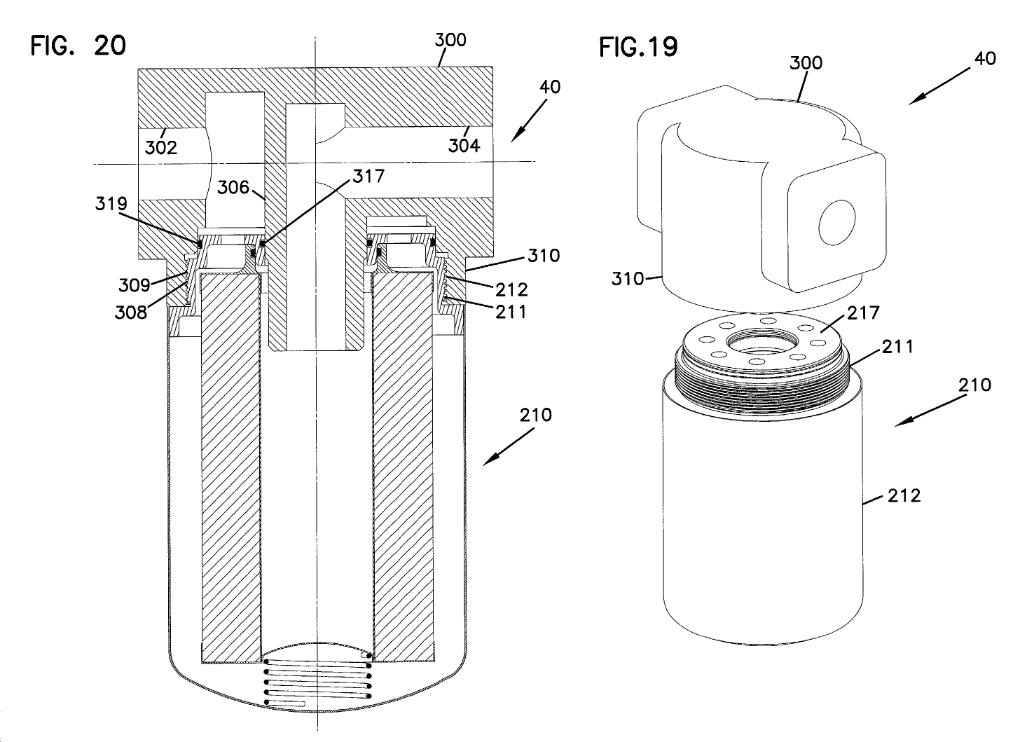

In FIGS. 19 and 20, the filter head 300 of FIGS. 17 and 18 is shown used with a spin-on canister filter 210. This is the same spin-on canister filter 210 depicted in FIGS. 9 and 10. Note that the threads 211 of the spin-on canister filter engage the threads 308 of the filter head 300 to provide for operable connection. Seals are formed between the filter 210 and the filter head 300 at 317, 319.

The filter head 300 can accommodate both the bowl-cartridge filter 162 and the spin-on canister filter 210, interchangeably.

The above specification, examples and data provide a complete description of the invention. Many embodiments of the invention can be made.

What is claimed is:

1. A liquid filter assembly comprising:
(a) a filter head; said filter head having a center tube, an outer tube, a first liquid flow port, and a second liquid flow port; said outer tube circumscribing said center tube;
(i) said outer tube defining an end, an outer tube end port at said end, and an outer tube flow passageway extending between and in fluid communication with said first liquid flow port and said outer tube end port;
(A) said outer tube further including an outer tube threaded region;
(ii) said center tube defining a center tube flow passageway and a center tube end port; said center tube flow passageway extending between and in fluid communication with said center tube end port and said second liquid flow port;
(A) said center tube projecting outwardly from said end of said outer tube;
(B) said center tube defining a center tube threaded region;
(b) a filter operably connected to said filter head; said filter having a housing defining an interior and a cartridge filter operably oriented within said housing interior;
(i) said filter having a filter threaded region threadably engaged to one of said outer tube threaded region and said center tube threaded region to form a threaded connection;
(ii) said filter being in liquid flow communication with said outer tube end port and said center tube end port;
(c) a first seal arrangement; said first seal arrangement oriented to form a first seal to inhibit leakage between said outer tube flow passageway and said filter; and
(d) a second seal arrangement; said second seal arrangement oriented to form a second seal to inhibit leakage between said center tube flow passageway and said filter.

2. A liquid filter assembly according to claim 1 wherein:
(a) said filter comprises a bowl-cartridge filter;
(i) said housing being re-usable; and
(ii) said cartridge filter being selectively replaceable within said housing.

3. A liquid filter assembly according to claim 2 wherein:
(a) said threaded connection is between said outer tube threaded region and said filter threaded region;
(i) said filter threaded region being on an exterior portion of said housing;
(ii) said outer tube threaded region being on an interior portion of said outer tube.

4. A liquid filter assembly according to claim 2 wherein:
(a) said threaded connection is between said outer tube threaded region and said filter threaded region;
(i) said filter threaded region being on an interior portion of said housing;
(ii) said outer tube threaded region being on an exterior portion of said outer tube.

5. A liquid filter assembly according to claim 1 wherein:
(a) said center tube threaded region is along an outer portion of said center tube and has a circular cross-section; and
(b) said center tube further includes a sealing region on said outer portion of said center tube;
(i) said center tube threaded region being oriented between said sealing region and said center tube end port; said sealing region having a circular cross-section with a diameter larger than a diameter of the cross-section of said center tube threaded region.

6. A liquid filter assembly according to claim 1 wherein:
(a) said filter comprises a spin-on canister filter;
(i) said housing being single-use; and
(ii) said cartridge filter being permanently, and non-replaceably mounted within said housing.

7. A liquid filter assembly according to claim 6 wherein:
(a) said threaded connection is between said center tube threaded region and said filter threaded region;
(i) said filter threaded region being on a baffle plate;
(b) said first seal arrangement includes a face seal formed between and against said baffle plate and said end of said outer tube.

8. A liquid filter assembly according to claim 6 wherein:
(a) said threaded connection is between said outer tube threaded region and said filter threaded region;
(i) said filter threaded region being on an exterior portion of said housing;
(ii) said outer tube threaded region being on an interior portion of said outer tube.

9. A liquid filter assembly according to claim 6 wherein:
(a) said threaded connection is between said outer tube threaded region and said filter threaded region;
(i) said filter threaded region being on a baffle plate; and
(ii) said outer tube threaded region being on an exterior portion of said outer tube.

10. A liquid filter assembly comprising:
(a) a filter head; said filter head having a center tube, an outer tube, a first liquid flow port, and a second liquid flow port; said outer tube circumscribing said center tube;
(i) said outer tube defining an end, an outer tube end port at said end, and an outer tube flow passageway extending between and in fluid communication with said first liquid flow port and said outer tube end port;
(A) said outer tube further including an outer tube threaded region;
(ii) said center tube defining a center tube flow passageway and a center tube end port; said center tube flow passageway extending between and in fluid communication with said center tube end port and said second liquid flow port;
(A) said center tube projecting outwardly from said end of said outer tube;
(B) said center tube having a center tube threaded region on an outer surface of said center tube; said center tube threaded region having an outer diameter;
(C) said center tube further including a sealing region on said outer surface of said center tube; said center tube threaded region being oriented between said sealing region and said center tube end port; said sealing region having an outer diameter larger than the outer diameter of said center tube threaded region;
(b) a filter operably connected to said filter head; said filter having a housing defining an interior and a cartridge filter operably oriented within said housing interior;
(i) said filter having a filter threaded region threadably engaged to said outer tube threaded region;
(ii) said filter being in liquid flow communication with said outer tube end port and said center tube end port;
(c) a first seal arrangement; said first seal arrangement oriented to form a first seal to inhibit leakage between said outer tube flow passageway and said filter; and
(d) a second seal arrangement; said second seal arrangement oriented to form a second seal against said center tube sealing surface to inhibit leakage between said center tube flow passageway and said filter.

11. A liquid filter assembly according to claim 10 wherein:
(a) said filter comprises a bowl-cartridge filter;
(i) said housing being re-usable; and
(ii) said cartridge filter being selectively replaceable within said housing.

12. A liquid filter assembly according to claim 11 wherein:
(a) said filter threaded region is on an exterior portion of said housing; and
(b) said outer tube threaded region is on an interior portion of said outer tube.

13. A liquid filter assembly according to claim 11 wherein:
(a) said filter threaded region is on an interior portion of said housing; and
(b) said outer tube threaded region is on an exterior portion of said outer tube.

14. A liquid filter assembly according to claim 10 wherein:
(a) said filter comprises a spin-on canister filter;
(i) said housing being single-use; and
(ii) said cartridge filter being permanently, and non-replaceably mounted within said housing.

15. A liquid filter assembly according to claim 14 wherein:
(a) said filter threaded region is on an exterior portion of said housing; and
(b) said outer tube threaded region is on an interior portion of said outer tube.

16. A liquid filter assembly according to claim 14 wherein:
(a) said filter threaded region is on a baffle plate; and
(b) said outer tube threaded region is on an exterior portion of said outer tube.

17. A liquid filter assembly comprising:
(a) a filter head; said filter head having a center tube, an outer tube, a first liquid flow port, and a second liquid flow port; said outer tube circumscribing said center tube;
(i) said outer tube defining an end, an outer tube end port at said end, and an outer tube flow passageway extending between and in fluid communication with said first liquid flow port and said outer tube end port;
(A) said outer tube further including an outer tube threaded region;
(ii) said center tube defining a center tube flow passageway and a center tube end port; said center tube flow passageway extending between and in fluid communication with said center tube end port and said second liquid flow port;
(A) said center tube projecting outwardly from said end of said outer tube;
(B) said center tube further including a center tube threaded region;
(b) a filter operably connected to said filter head; said filter having a housing defining an interior and a cartridge filter operably oriented within said housing interior;
(i) said filter having a filter threaded region threadably engaged to said center tube threaded region to define a threaded connection;
(A) said threaded connection having a cross-sectional thickness no greater than 10 mm;
(ii) said filter being in liquid flow communication with said outer tube end port and said center tube end port;
(c) a first seal arrangement; said first seal arrangement oriented to form a first seal to inhibit leakage between said outer tube flow passageway and said filter; and
(d) a second seal arrangement; said second seal arrangement oriented to form a second seal to inhibit leakage between said center tube flow passageway and said filter.

18. A liquid filter assembly according to claim 17 wherein:
(a) said filter comprises a spin-on canister filter;
(i) said housing being single-use; and
(ii) said cartridge filter being permanently, and non-replaceably mounted within said housing.

19. A liquid filter assembly comprising:
(a) a filter head; said filter head having a center tube, an outer tube, a first liquid flow port, and a second liquid flow port; said outer tube circumscribing said center tube;
(i) said outer tube defining an end, an outer tube end port at said end, and an outer tube flow passageway extending between and in fluid communication with said first liquid flow port and said outer tube end port;
(A) said outer tube further including an outer tube threaded region;
(ii) said center tube defining a center tube flow passageway and a center tube end port; said center tube flow passageway extending between and in fluid communication with said center tube end port and said second liquid flow port;
(A) said center tube projecting outwardly from said end of said outer tube;
(b) a filter operably connected to said filter head; said filter having a housing defining an interior and a cartridge filter operably oriented within said housing interior;
(i) said filter having a filter threaded region threadably engaged to said outer tube threaded region to define a threaded connection;
(A) said threaded connection having a cross-sectional thickness no greater than 10 mm;
(ii) said filter being in liquid flow communication with said outer tube end port and said center tube end port;
(c) a first seal arrangement; said first seal arrangement oriented to form a first seal to inhibit leakage between said outer tube flow passageway and said filter; and
(d) a second seal arrangement; said second seal arrangement oriented to form a second seal to inhibit leakage between said center tube flow passageway and said filter.

20. A liquid filter assembly according to claim 19 wherein:
(a) said filter comprises a bowl-cartridge filter;
(i) said housing being re-usable; and
(ii) said cartridge filter being selectively replaceable within said housing.
